(19) United States
(12) Patent Application Publication
(10) Pub. No.: US 2013/0282360 A1
(43) Pub. Date: Oct. 24, 2013

(54) Method and Apparatus for Translating and Locating Services in Multiple Languages

(71) Applicants: James A. Shimota, Chicago, IL (US); Lawrence Lien, Los Altos, CA (US); Kenneth H. Bridges, Palo Alto, CA (US)

(72) Inventors: James A. Shimota, Chicago, IL (US); Lawrence Lien, Los Altos, CA (US); Kenneth H. Bridges, Palo Alto, CA (US)

(21) Appl. No.: 13/866,219

(22) Filed: Apr. 19, 2013

Related U.S. Application Data
(60) Provisional application No. 61/636,400, filed on Apr. 20, 2012.

(51) Int. Cl. G06F 17/28

(52) U.S. Cl. CPC G06F 17/28
USPC 704/7; 704/8

(57) ABSTRACT

A system providing a mobile foreign language database and associated equipment. The system enables real time or near real time searching for foreign language business and real time or near real time learning of foreign languages.

### RELATED APPLICATIONS

The present application claims the benefit of U.S. Provisional Application No. 61/636,400, entitled “Method and Apparatus for Translating and Locating Services in Multiple Languages,” filed on Apr. 20, 2012 which is hereby incorporated by reference herein in its entirety.

### TECHNICAL FIELD OF THE INVENTION

The field of the invention is computer networks and computer databases.

### BACKGROUND OF INVENTION

Groups of people such as immigrants live in countries in which members of the group speak and feel most comfortable using a foreign language that is different from the official language used in the country of residence. In some cases, members of the group may have little or no fluency in the official language of the location, relying entirely on their foreign native language in their daily lives. Members of these groups typically seek out businesses (e.g., bakeries, hotels, etc.) and services (e.g., doctors, lawyers, accountants, etc.) that have the capability to serve them in their foreign native language.

In the past, members of these groups have obtained specialized phone books—sometimes called “Yellow Pages”—providing a database or other listing of businesses and services with employees fluent in a single desired language (e.g., “Polish Yellow Pages”). More recently, specialized single foreign language databases have become available via the Internet on web sites.

Although these web sites may partially address needs of a particular foreign language community, they all suffer the disadvantage of being targeted at a specific group. Thus, the members of a particular community are only provided business and service options from a small pool of entities catering to a language, minimizing their choices. This problem is made worse by the fact that many individuals may not be able to find the physical location of some or all of the options because they are not fluent in the predominant native language.

Another disadvantage of these foreign language web sites is that potential advertisers and businesses are discouraged from spending resources to reach out to particular groups that do not feel most comfortable with a foreign language because of their relatively small size. Existing web sites tailored to a particular language (such as, for example, www.polishpages.us) also fail to provide tools to assist members of the foreign language community learn to speak the predominant language of a country of residence. Similarly, existing web sites and associated software also do not take into account the different preferences members of a foreign language group may have based on factors such as country of origin (e.g., Spanish speakers from Mexico versus Spanish speakers from Puerto Rico.) Moreover, the existing web sites and associated software are not designed for and are unsuitable for mobile devices such as smartphones and navigation systems in automobiles.

Moreover, there currently are no voicemail/messaging systems that adequately assist users in handling incoming phone calls from callers that do not speak the users foreign language. Accordingly, individuals that do not speak the predominant language in a location may be unable or too uncomfortable to answer many phone calls, oftentimes missing potentially valuable information.

### SUMMARY OF THE INVENTION

The present invention addresses the above-identified problems and further provides advantages over the prior art for people in multi-language situations, including foreign language speaking immigrants, travelers to foreign language speaking countries, and visitors to foreign language speaking neighborhoods within a country. Embodiments of the present invention may be used to create a multi-lingual network that allows users to search for businesses and services by location and language. In certain embodiments, the present invention provides greater choice to users by also searching for businesses that provide services in secondary languages understood by a user and (if appropriate) e-commerce alternatives that can be translated. In certain embodiments, the present invention also provides translated directions to businesses and services that can serve foreign language businesses.

The multi-lingual network also provides a flexible system allowing third parties (or a party offering a system in accordance with the present invention) to target some or the whole group of foreign language speakers and distribute materials (e.g., coupons, business advertisements, classified advertisements, personal advertisements including social networking pages like Facebook, personal newsfeeds such as Twitter, etc.) to a group. Certain embodiments of the present invention also allow users to provide feedback (e.g., applying for a job, indicating a preference for certain types of products, responding to a personal newsfeed, etc.). In exemplary embodiments, certain types of feedback can be used to suggest particular types of foreign language groups as advertising targets (or alternately to identify a particular group as an unsatisfactory target).

Moreover, the present invention provides a practical vehicle for learning a new language in real world situations. For example, in certain embodiments, the present invention allows users to scan bar code for products of interest, and learn the predominant language words associated with those products. Similarly, in further embodiments of the present invention, users are provided an interface through which advertisements such as coupons can be treated as virtual flash cards, providing another means to learn a language in a real world setting. In another exemplary embodiment, users of the present invention will be able to take pictures, search for the components of the pictures with a visual search engine and learn the native predominant language words associated with the components of the picture.

Further, embodiments of user software provided with the present invention allows users to filter incoming phone calls, and receive translations of voicemail messages from callers that leave messages in the predominant language of the location. Such embodiments of the present invention ensure that users do not miss important phone messages (such alerts concerning power outages).

One of ordinary skill in the art will appreciate that the embodiments of the present invention can be implemented with existing networking equipment and software. The ordinary artisan will also appreciate that the present invention is sufficiently flexible to accommodate new networking equipment and software packages.

### DRAWINGS

FIG. 1 illustrates an exemplary network for use with the present invention.

FIG. 2 illustrates an exemplary smartphone that could be used with the present invention.

FIG. 3 illustrates an exemplary search using the personal assistant software of the present invention.

FIG. 4 illustrates an exemplary third party business submission of an advertisement using the present invention.

FIG. 5 illustrates a flash card type user interface for advertisements useful for learning a different language.

Before embodiments of the invention are described in detail, one skilled in the art will appreciate that the invention is not limited in its application to the particular details, the arrangements of components, and the arrangement of steps set forth in the following detailed description or illustrated by the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The present invention allows an advertiser (e.g., a company, government entity, non-profit corporation, etc.) to submit information about itself to either a discrete audience (i.e., speakers of a foreign language) or more broadly to many different groups. In one embodiment, the information provided by the advertiser includes one or more optional physical locations and fluency in one or more foreign languages (if any). Of course, an advertiser could and preferably would submit additional information such as brands carried. One of ordinary skill in the art will understand the types of information that may be stored in a “Yellow Pages” type directory.

With the present invention, users of, for example, smartphones equipped with GPS will be able to search for and to locate businesses, services, employment, etc. that are able to support the user's foreign language. In a preferred embodiment of the present inventions, in addition to or as an alternative to manual searches, a user will be able to perform such searches speaking into the microphone of a smartphone or vehicle navigation system using technology such as Apple's SIRI search engine.

The present invention moreover provides individuals who do not speak the predominant language in a location access to goods and services they otherwise would have difficulty locating. For example, using the present invention, a business such as local grocery store would be able to submit a coupon in the predominant language of that location that would be translated into all the foreign languages of subscribers within a geographical area (or a subset of the subscribers) and then transmitted to those subscribers. In an embodiment of the present invention, the translation of the exemplary coupon could be accomplished using, for example, publicly available translation services and accompanying application programming interfaces (“APIs”). As an example, Microsoft provides a service and API known as Translator, and Google provides a service and API known as Translate. Similarly, myGengo and SpeakLite also provide services and APIs. The documentation for Microsoft's Translator service and API is available at http://www.microsofttranslator.com/dev/, which is hereby incorporated by reference. Similarly, an employer looking for part-time labor could likewise transmit a translated classified advertisement to local subscribers. In an exemplary embodiment, a local subscriber could specify the type of part-time labor they wished to receive notice (e.g., nanny, yard work, etc.).

The present invention further provides a practical, real time tool for someone unfamiliar with the predominant language in a country (e.g., immigrants, tourists, students, etc.) to learn that language. For example, in an exemplary embodiment, information pushed to subscribers such as coupons could be provided (and optionally printable) in the predominant and foreign languages. Moreover, using commercially available speech recognition technology, information such as the coupons could be read aloud in the foreign and predominant languages by, for example, a smartphone to a subscriber. As an example, Microsoft's Tellme Interactive Voice Response (IVR) Service provides text-to-speech (TTS) service. Similarly, OpenEars provides technologies for text-to-speech. The documentation for OpenEars is available at http://www.politepix.com/openears, which is hereby incorporated by reference. The present inventions therefore allow a subscriber to learn a new language in real time while performing common tasks such as shopping for groceries or reading a third parties' personal newsfeed on Twitter.

In another embodiment of the present invention, a user can employ bar code scanning, near field communication or similar technology to have a smartphone recognize certain items. Once the smartphone recognizes the item, the user can be informed aloud, via text or both of the predominant and foreign words corresponding with that item, further learning a language while experiencing the world.

In a further embodiment, using an optional visual search engine combined with the present invention, a subscriber could use the camera functionality available in most smartphones to further augment his or her learning of a foreign language. There currently exists a (growing) database of images that typically include metadata for identification information. Examples of metadata include a field called a “tag” or otherwise textual identification information. In this particular embodiment, to aid learning the predominant language in a location, a user of the present inventions can take a picture of an item such as a dog, flower, etc., and then transmit the image to visual search engine software such as Retrievr, RevIMG, or other visual search engines which can match the photo with a database of images provided by, for example, Flickr. As another example, Picitup offers several products and APIs such as the Picitup API and Picliq for implementing visual search. The documentation for the Picitup API is available at http://www2.picitup.com/products/picsimilar-api, which is hereby incorporated by reference. The documentation for Picliq is available at http://www2.picitup.com/products/picliq, which is hereby incorporated by reference. Once a match is located, the user can be provided with the native and foreign language words for, for example, a dog or a flower.

In a further embodiment, the present inventions provide users automatic access to a foreign language version of travel web sites such as kayak.com. While these web sites may provide a user interface to switch from, for example, English to a foreign language, that user interface may itself be difficult for a user unfamiliar with computers and the default language of a web site. Through the use of optional databases, the present inventions provide a way to direct a user to the foreign language version of such web sites.

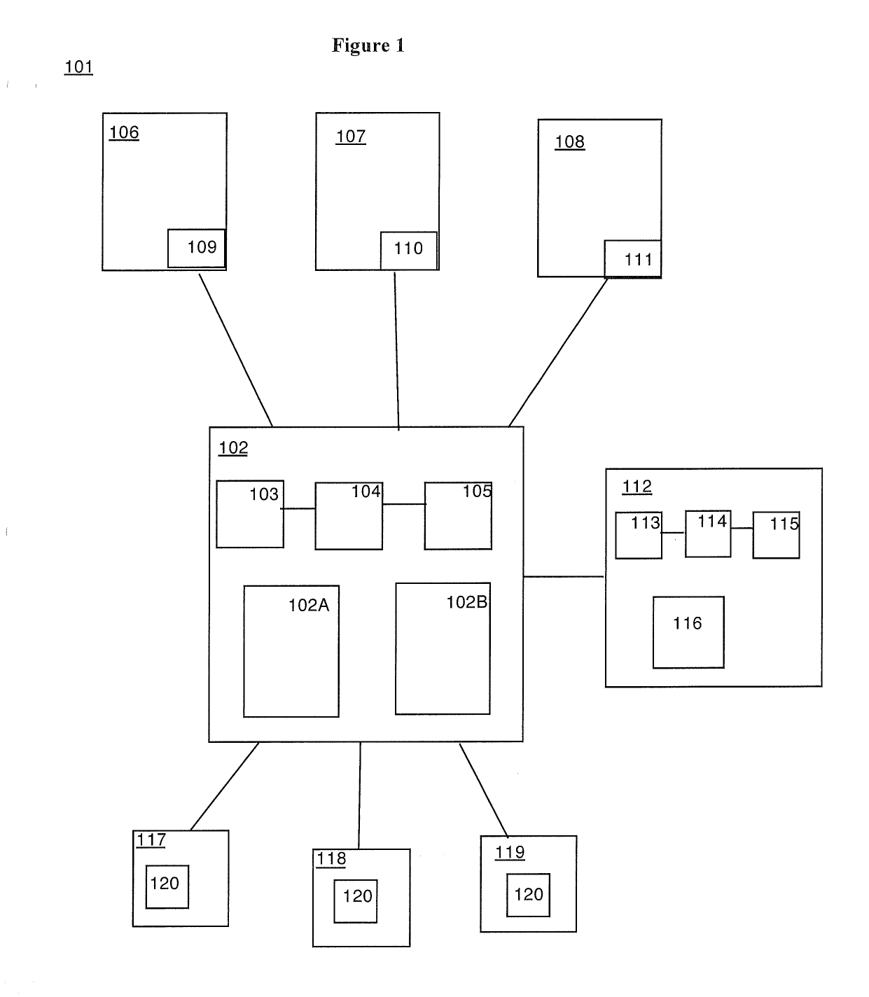

FIG. 1 illustrates an exemplary network 101 that could be used to implement the present inventions. Server 102 illustrates a conventional server commercially available from companies such as HP, Dell, IBM and Sun that could be used to store databases 102A of businesses and information concerning those businesses. As described above, in the preferred embodiment, the database will at least include the name of the business, its contact information (e.g., phone number, email (if applicable), and web address (if applicable)), its physical location (if applicable), the general type of business and the language or languages it supports. The database can include additional information such as brands carried, etc. The database will also include information concerning government entities and other public services. In a preferred embodiment, the database will include information on both the government for a location (e.g., Federal, State and local entities in the United States) and other government entities of interest (e.g., a country's embassy or consulate office). Further, the database will include information concerning utility companies even if a particular utility company only supports the language of the predominant location. As described further below, server 102 optionally includes additional databases 102B that include information about different foreign language groups. In an exemplary embodiment, databases 102B could be a matrix that includes groups, goods and services regarded as inappropriate by each particular group and a calendar of events associated with each particular group. The databases 102B are useful to avoid translating an advertisement from a third party business and then sending the advertisement to an inappropriate group. Likewise, the calendars in databases 102B are also useful in order to suggest to third party businesses advertising opportunities associated with one or more groups. Database 102B can also include positive feedback from groups including, for example, particular types of products enjoyed by one or more foreign language groups. Database 102B may also include information identifying related languages (e.g., Mandarin and Cantonese).

Further, the server 102 may also include a database of information concerning users of the personal assistant software (described further below) such as an email address, physical address, registered primary language, country of origin, etc. As will be appreciated by one of ordinary skill in the art, additional personal information may be stored in the server 102 including, for example, age, gender and a particular user's preferences.

In an optional embodiment, for mobile businesses and services, information concerning the physical location of such businesses may be updated periodically. For example, a traveler may wish to order a taxi cab where the taxi cab driver speaks the traveler's language. If the taxi cab has GPS capabilities or if the driver's smart phone (or other computing device) has GPS capabilities, server 102 and the taxi cab will communicate wirelessly periodically to update that taxi cab's location. This feature of the present invention allows an individual to locate the nearest mobile business that supports his or her language. The preceding discussion used a taxi cab as an example of a mobile business, but one of ordinary skill in the art understand that this feature can be used with any mobile business or service (e.g., ambulance, police squad cars, tour guides, etc.)

Server 102 includes a processor 103 (which could be one or more microprocessors), a memory 104 (which may be RAM, DRAM, SRAM, Flash memory, cache memory, etc. or a combination of different types of memory) and an operating system 105 (e.g., Linux, Windows, etc.). In an embodiment, server 102 may also include database software such as Microsoft SQL Server, Oracle, MySQL, and SQLite. While FIG. 1 illustrates a single server, it would be readily apparent to one of skill in the art that the present invention could be implemented with multiple servers, segregating databases as is efficient.

Servers 106, 107 and 108 also represent conventional servers maintained by third parties such as Google, Microsoft and Apple. By way of non-limiting illustration, server 106 could be one server (or many servers coupled together) that can execute foreign language translation software such as Google Translate or Microsoft Translator. Translation API 109 is an application programming interface allowing software on server 102 to use the translation software on server 106. Similarly, by way of non-limiting illustration, server 107 could be a server (or many servers coupled together) that can execute speech recognition software such as Apple Computer's SIRI software or Microsoft's Tellme Interactive Voice Response (IVR) Service. Speech recognition API 110 is an application programming interface allowing software on server 102 to the use the translation software on server 107. Finally, by way of non-limiting illustration, server 108 could be a server (or many servers coupled together) that can execute visual searches such as the Microsoft Bing Visual Search Engine. Visual search engine API 111 is an application programming interface allowing software on server 102 to use the visual search engine software on server 108. Servers 106, 107 and 108 are illustrated as separate servers in an embodiment to show that the present inventions can be used across multiple platforms (e.g., iPhone, Android smartphones, tablets, etc.) However, one of ordinary skill in the art will recognize that a single server group (e.g., from Google) could be used for both translation and speech recognition.

In addition, while an exemplary embodiment is described using third party speech recognition, translation and visual search software and their respective API's, one of ordinary skill in the art will also recognize that server 102 could be loaded with some combination of proprietary translation, speech and visual search software. In an exemplary embodiment, where server 102 is loaded with proprietary software, the individual translation, speech and visual search software will each have APIs so that the software packages will be modular.

One of ordinary skill in the art will of course recognize that the servers can communicate with one another and other computers (e.g., smartphones and third party business computers) via wired or wireless links.

Computer 112 is coupled to server 102. Computer 112 includes one or more processors 113, a memory 114 (which may be RAM, DRAM, SRAM, Flash memory, cache memory, etc. or a combination of different types of memory) and an operating system 115 (e.g., Windows, Apple OS X or Android). Computer 112 also runs advertising input software 116. As will be understood by one of ordinary skill in the art, advertising input software 116 may be a software module loaded on a computing device, it may be a web portal to a software module on the server 102 or a combination of both. As will be explained in greater detail below, advertising software 116 provides an interface for a entities (e.g., individuals, businesses, government entities, non-profit entities, etc.) to input advertisements that will subsequently be translated into other languages. One of ordinary skill in the art will readily recognize that computer 112 could be a laptop computer, a tablet computer, a smartphone or any other computing device.

Smartphone 117, tablet computer 118 and vehicle navigation system 119 illustrates exemplary devices that could be used to implement the present inventions. Similar to the servers and computer 112 described above, each of the devices 117, 118 and 119 include at least one processor, a memory and an operating system. These devices also include personal assistant software 120 configured, for example, to allow location- and language-based searches via a textual and/or speech user interface. Examples of publically available speech input services and APIs include Microsoft's Tellme Interactive Voice Response (IVR) Service and Android's RecognizerIntent. Documentation for Android's RecognizerIntent is available at http://developer.android.com/resources/articles/speech-input.html, which is hereby incorporated by reference. The details of personal assistant software 120 and optional features of personal assistant software 120 are discussed further below. One of ordinary skill in the art will readily recognize that, in addition to a smartphone, tablet computer and vehicle navigation system, the present inventions can also be used in other computing devices such as laptops, desktop computers, etc.

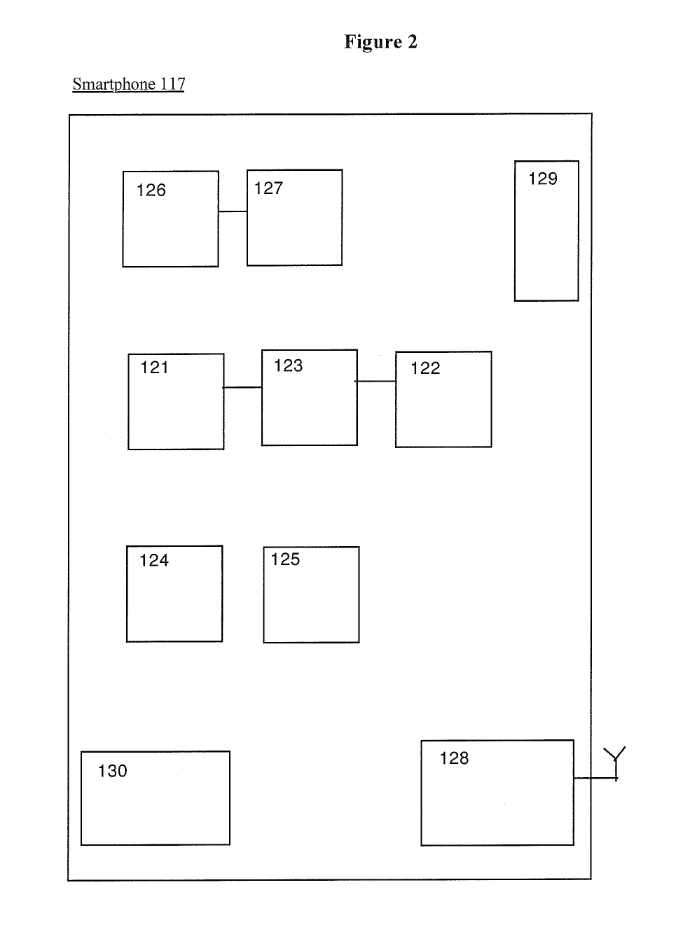

FIG. 2 illustrates an exemplary smartphone such as smartphone 117 (e.g., iPhone, Motorola Droid, etc.). As described above, smartphone is a conventional design and includes at least one processor 121, a memory 122 and an operating system 123. The smartphone further includes a microphone 124, speakers 125, a camera 126, memory to store an image 127 and a transceiver 128 including an antenna capable of transmitting and receiving voice and data over wireless networks (e.g., cellular, WiFi, etc.). Smartphone 117 also includes a display screen 129 that could (but need not) be a touchscreen. One of ordinary skill in the art will of course recognize that a smartphone may also include a standard keypad in addition to or as an alternative to a touchscreen to enable text input. One of ordinary skill in the art will also recognize that tablet computers and vehicle navigation system will include similar components and software.

To perform queries based on both location and language, it is desirable for the smartphone 117 to have GPS capabilities. In one embodiment, the smartphone could be equipped with a GPS receiver 130 and accompanying decoding logic to determine location. Alternately, in another embodiment, smartphone 117 could receive location information from, for example, a cellular network via a base station. In a further embodiment, as an alternative to or in addition to GPS capabilities, a user could also manually input his or her approximate location (if, for example, GPS was temporarily unavailable).

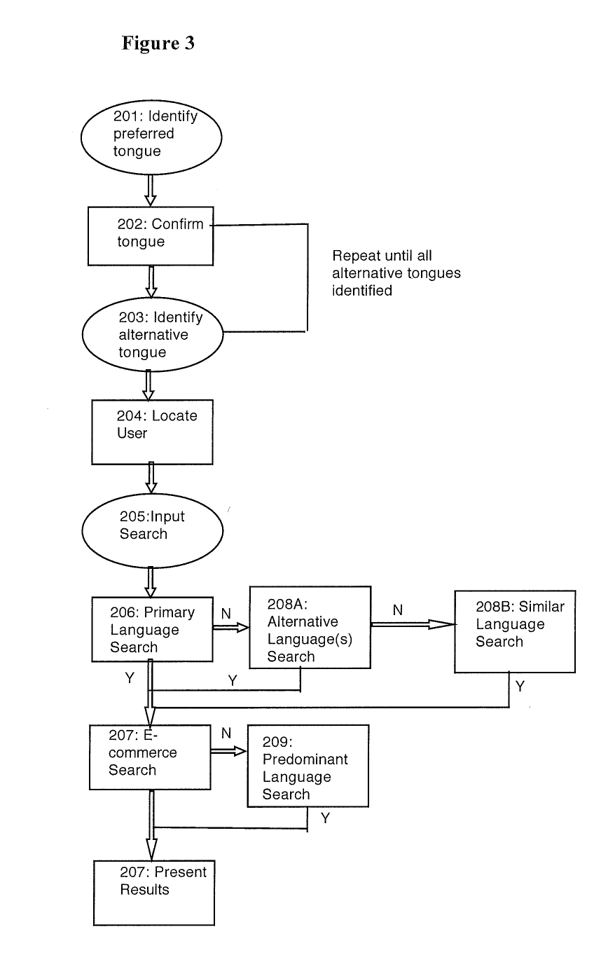

FIG. 3 illustrates an exemplary search using personal assistant software 120 in accordance with the present invention. At step 201, a user identifies his or her foreign language. In one exemplary embodiment, the personal assistant software 120 could be configured to recognize the language set in the smartphone when it is first activated after purchase. In another exemplary embodiment, the user can say the word associated with his language (e.g., “German”) and/or begin speaking in his or her native tongue, and the personal assistant software 120 will begin searching for those words in a database such as that used by SIRI. When a matching language is located, it can be presented to the user and then confirmed. In another exemplary embodiment, a user could select his or her country's flag on a screen using a touch screen or a keyboard, and the personal assistant software 120 would register the language associated with that country. In a further exemplary embodiment, a user could type words from his or her language into, for example, a dialog box, and the personal assistant software 120 would recognize those words using translation software. In an additional embodiment, a user could select his or her language when downloading the personal assistant software 120 from a marketplace such as the Android marketplace. For example, at the Android marketplace, selection of the main software package could reveal a submenu with icons of particular countries flags for selection by the user. Optionally, at step 202, the personal assistant software 120 would ask a user to confirm via, for example, a Yes/No Pop Up that it had registered the correct language. In a further optional embodiment, the personal assistant software 120 will also ask a user to identify and confirm his or her particular dialect (e.g., American English, Australian English, etc.) to provide for better speech recognition.

As a further option, at step 203, the user may identify an alternative choice (and third, fourth, etc.) tongue. As an example, a Polish user may have learned Russian in school, and could input as a secondary choice when Polish options are not available/convenient. At step 204, as described above, the GPS functionality in the smartphone locates the user. At step 205, the user would input a query for a desired business, service, etc. For example, the user who had previously registered as Polish speaking could search for bakeries. As described above, the query can be input via speech or manually. At step 206, the personal assistant software 120 will query the database(s) in server 102 to determine if there are matches within a desired radius (e.g., 10 miles). One of skill in the art will recognize that the desired radius can be adjustable, and could be set by the user. At step 207, the personal assistant software 120 will also search the database for e-commerce substitutes to traditional brick and mortar stores that have been translated into a foreign language and/or are available in the foreign language. As optional embodiment, if the search at step 206 yields no results, in addition to alternative languages (described above), the personal assistant software 120 can also search for businesses where a related (i.e., similar) language is spoken. Examples of related languages include (1) Mandarin and Cantonese and (2) Polish and Slovak.

Continuing the example above, at step 208A, where there are no Polish bakeries within a desired radius and the user has identified Russian as an alternative language, the personal assistant software will search for Russian bakeries. However, if there are no Polish bakeries within the desired radius and no Russian bakeries, at step 208B, the personal assistant software 120 will search for bakeries where, for example, Slovak is spoken. Finally, if no related language businesses are located as well, at step 209, the personal assistant software 120 can search for the nearest businesses where the native language is spoken. At step 210, the user will be presented with the results from the personal assistant software 120. The server 102 can maintain a database of native language business, or, alternately, the personal assistant software 120 could also query existing databases such as www.yelp.com.

If the searches at steps 206 and 207 yield positive results, in the preferred embodiment, the user will be presented first with the nearby Polish speaking bakeries and then, as an alternative, on-line bakeries that have been or can be translated into Polish. In the preferred embodiment, the nearby bakeries will be shown on a map on the smartphone 117 such as maps provided by Google Maps, and the directions to those businesses will be translated into selected foreign language by the translation software. If the search at step 206 is negative, step 207 is positive and step 208 is positive, in the preferred embodiment, the user will be presented with the on-line bakeries that have been or can be translated into Polish first and then the nearby Slovak bakeries second. Finally, if the searches at steps 206, 207 and 208 are all negative, in an exemplary embodiment, the user will be presented with native language options at step 209. One of ordinary skill in the art will recognize that the order and amount of information presented to the user can be varied.

Identifying e-commerce options presents a useful alternative to non-native speakers who traditionally have had to purchase items such as travel packages (flights, hotels, etc.) from travel agents who speak their language. It would be desirable for non-native speakers to have easy access to all options in order to obtain the best deals from a live travel agent or via a web site. Step 207 of the present inventions provides a solution to that problem by directing a user to native speaking travel agents and then, for example, an e-commerce site such as kayak.com if that site has that registered with server 102.

Moreover, in an optional embodiment, the present inventions make sure that a user that navigates to an identified e-commerce site will reach a foreign language appropriate version of that site. While some sites such as kayak.com provide translation capabilities and attempt to make that capability user intuitive, many non-native speakers (particularly those who are not computer savvy) will be discouraged by and often quickly leave a native version of a web site. To avoid that problem, if a particular site has translation capability, server 102 can, for example, store the url addresses of, cookies associated with, etc. the translated versions of a particular site. Thus, when a user selects an e-commerce search result from step 207 (manually or via speech recognition tools), he or she will be directed to version of the site in his or her language in the first instance, avoiding the need to first ascertain the translation capability of the site and then determine how to use that capability.

Moreover, in an alternative optional embodiment, the database can also track web sites that do not have the ability to be translate into one or more languages supported by the personal assistant software. For example, www.kayak.com does not presently provide the option for the web site to be translated into Polish. To address this issue in this optional embodiment, the database in server 102 will track web sites that have incomplete translation capabilities.

For a web site such as kayak.com that currently has incomplete translation capabilities, if selected by a Polish user in response to a search for travel agents, software on the server 102 could automatically provide a translated version of that particular web site using the infrastructure and methods described above. In one example embodiment, at least portions of the translation of the website functions as the Google Chrome web browser. In the non-limiting example of Google Chrome's web browser and a Polish user attempting to use www.kayak.com, software on server 102 will be configured (1) to optionally open a different language version of kayak (e.g., www.kayak.de if the user is in America) that will provide the best source language for translation and (2) to automatically manipulate the Chrome user interface to translate the page into Polish. In the non-limiting example of Google Chrome, as illustrated by the screen shots in FIGS. 6 and 7, the software would need (1) to first automatically activate the “Translate” button to translate from German to English and (2) to then automatically choose to translate from “German” to “Polish” via the user interface. In this example of the invention, the Polish user (or any other foreign language user of the personal assistant software) will automatically obtain access to a foreign language version of kayak.com that would otherwise be unavailable. Although described with reference to Google Chrome as an example, one of ordinary skill in the art would recognize that any web browser with translation capabilities could be used, or a web browser could be used and combined with translation capabilities as described above to achieve similar results. In one exemplary embodiment, a plug-in (or extension) is installed in the browser to communicate with the server 102. The plug-in would, alone or in combination with server 102, determine if a translated version of the web site exists. If one does not exist, the plug-in would receive a translated version of the web site using the methods described above for automatic presentation to the user. In one exemplary embodiment, the server 102 performs the translation and sends results to the user's browser equipped with the plug-in. In another embodiment, pre-translated versions of portions of the website are stored by the server 102. In a further exemplary embodiment, the plug-in performs the translation without the server using a Translation API as described above.

In a further optional embodiment, the results of searches may be presented to users in a hierarchical user interface. For example, upon completion of a search for a particular type of business or service, a user interface would present to the user a menu with the following options (if applicable for a given search): (1) Primary Language Options; (2) Alternative Language Options; (3) Related Language Options and (4) E-Commerce Options. One of ordinary skill in the art will recognize that there are numerous well know techniques to present this type of menu. When a user selects one of the options (e.g, by touching the option on a touchscreen), the user will be directed to at least a second level of the hierarchy in which the businesses for that option are presented. The second level may include another menu further refining search results. For example, if a user had searched for a bakery, the second level could include a menu with the following options: (1) Specialty Bakeries and (2) Groceries, allowing a user to proceed to lower levels in the hierarchy. Based on present disclosure, one of ordinary skill in the art will understand that additional levels in the hierarchy could be added as appropriate.

The present inventions are useful not only to permanent resident of a location but also to travelers (e.g., tourists). In an optional embodiment, a user of smartphone 117 can inform personal assistant software 120 via its user interface that he or she is traveling. Alternately, if the personal assistant software detects via GPS capabilities that a user is away from his usual location (e.g., 50 miles or more) for an extended duration (e.g., 24 hours), personal assistant software 120 could query a user via, for example, a pop up dialog whether he or she is traveling. In the event that a user is traveling, the steps in FIG. 3 may be modified (at the request of a user). For example, step 207 may (but need not) be eliminated so that only local businesses that have employees speaking the tourist's language are identified. In that scenario, the tourist may only be interested in exploring the local options rather than comparing e-commerce options as he or she might desire when at home.

In a further embodiment, the present invention can also be used for a further type of search. There currently exists software and hardware in, for example, smartphones that enable users to gain access to information regarding products. For example, using a smartphone's camera functionality, a smartphone equipped with specific software (such as, for example, the Red Laser application) can take a picture of a bar code and provide a user with information such as comparison prices for that product at e-commerce stores. One of ordinary skill in the art will recognize a similar search could be performed by a smartphone equipped with near field communication (NFC) transceiver and decoding logic if a particular good and/or its packaging was equipped with an NFC transmitter. One of ordinary skill in the art will also recognize that a similar product search could also be performed using an application such as Flow by Amazon loaded on a smartphone. The Flow application allows a user to take a picture of a product, and then identifies that product and all related products in the Amazon.com database.

In the case of a foreign language speaker, that individual may be interested in an item he or she encounters while browsing, but may wish to ask detailed questions in his or her language before seriously considering making a purchase. Thus, in an exemplary embodiment, the database of businesses in server 102 may also include information on the brands and/or models carried by some or all of the businesses (if appropriate). In addition, using existing technology as described above, the bar code recognition software and hardware on, for example, the smartphone 117 will allow a user to take a picture of a bar code and then recognize the product corresponding with that bar code. Once the product is recognized, the personal assistant software 120 will begin searching starting at step 204 in FIG. 3 for a business that speaks the user's language and also carries that particular product. In one embodiment, if no nearby businesses are located, the search could be modified to identify stores where competing products are sold so that the user could ask questions about the type of product. Similarly, in another embodiment, if no nearby businesses are located, the search could be modified to locate any stores in the United States so that the user could at least speak on the phone regarding the product.

The alternative search described above has the additional benefit that it may (but is not required to be) used as a real time tool for foreign language speakers to learn the predominant language in a location. By using bar code scanning technology and the publicly available speech recognition and translation software discussed above, users will be able to learn translations of words associated with items of interest as they are encountered in real time. For example, a user interested in carpentry browsing a hardware store might encounter a hammer, and then scan the bar code for the hammer. The personal assistant software of the present inventions can be configured to identify (and repeat aloud if selected by the user) the native and foreign language words associated with that product. As will be appreciated by one of ordinary skill in the art, in addition to products, entities may provide bar codes (or another type of OCR) via, for example, stickers on the entrance to the physical location of an entity. Alternately, an entity could provide a near field communication (NFC) transmitter that provides information about products or services which could be translated as described above.

In a preferred embodiment, the personal assistant software will repeat aloud the predominant local language translation of a selected product (or information about a business, etc.) in the dialect of that region (e.g., Australian English in Australia.) In a further optional embodiment, the personal assistant software can also support sub-dialects (e.g., English in the Southeastern United States vs. English in the Northeastern United States). The locations where different dialects are spoken and different dialect recordings can be stored in server 102, and personal assistant software will be able to recognize a location via GPS, etc.

In an optional embodiment, a user of the personal assistant software will be allowed to set default dialects (or sub-dialects) for translations using searches with the present invention (e.g., a Chinese individual residing and working in America goes on vacation to Australia). In this non-limiting example, the Chinese user would be asked via, for example, a pop up window if he or she would prefer to continue hearing American English while in Australia. This optional embodiment permits a user of the personal assistant software to learn a language in a chosen dialect or sub-dialect—e.g., an immigrant in Texas may wish to hear and mimic English with a Midwestern U.S. English sub-dialect while another immigrant in Texas may wish to hear and mimic English with a Southwestern U.S. English sub-dialect.

The language learning aspect of the alternative product search is not limited to foreign language speakers in a particular location. For example, a student could configure the software to identify items in whatever languages he or she chose (e.g., an American student could configure the software to identify the hammer in English and then in French).

Similarly, the personal assistant software could also optionally include a visual search capability or access visual search engines provided by third parties. As one example, Google provides an option for a user to take a picture. If that picture is recognized in a database, Google Goggles will provide the user data tagged with that picture. In the case of the present inventions, similar to the bar code scanner, a user of personal software could take a picture of a business of interest (e.g., a bakery) and then ask the personal assistant software via speech recognition software or manual input to locate similar businesses where foreign language is spoken. The personal assistant software would then proceed through the steps of FIG. 3.

Moreover, in an alternative embodiment using visual search capabilities, the steps of FIG. 3 could be modified to locate all business supporting foreign language within a particular radius. For example, a tourist could take a picture of a street intersection or tourist attraction (e.g., Golden Gate Bridge), and ask the personal assistant software via speech recognition or manual input to locate all foreign language speaking businesses. Continuing the example, a Russian tourist near the Golden Gate Bridge may desire to find any business where Russian is spoken in order to ask questions about San Francisco.

In a further embodiment, using visual search engines in combination with the personal assistant software will also provide another practical way to learn a language in real time. As discussed above, there are numerous databases of photographs (e.g., Flickr, Kodak Gallery, etc.) that exist today and continue to grow. The photos in these databases typically have metadata, such as tags, associated with them. The personal assistant software can therefore use visual search capabilities provided via APIs by, for example, Google to search for pictures taken by the user. In one embodiment, a user might take a picture of his dog. After taking this picture, a user could audibly query the personal software to identify what he or she sees in the picture. Once the visual search engine finds a match in a database (i.e., another picture of a dog), it would return that information to the personal software. The personal assistant software then would translate the word “dog” into the registered foreign language and provide it to the user audibly via a speaker and/or on the screen of the smartphone. In an exemplary embodiment, the personal assistant software might state in the appropriate language—“You are looking at a dog which in English is a [Insert Translation].” As described above, the translation repeated aloud may be in the particular dialect of a location.

In an optional embodiment, the personal assistant software could provide real time or near real time “augmented reality” to reinforce the learning process. For example, after the smartphone captures and image of the dog and finds a match in a database, the personal assistant software would register and store that match in the memory of the smartphone. Thereafter, the personal assistant software could place a label over the image of the dog on the screen of a smartphone when the user points his or her smartphone at the dog again. For example, the label “Dog; [Translation of Dog]” would appear on the screen, and, if requested, the smartphone could repeat “You are looking at dog which in English is a [Insert Translation.]”

Users of the personal assistant software may take pictures with multiple subjects. Extending the example above, a user could take a picture of his dog sleeping under a tree where the tree is also next to a bed of flowers. There exist prior art solutions to breaking digital images into components, and searching for those components in databases of pictures. An exemplary prior art solution is U.S. patent application Ser. No. 11/535,469. In an optional embodiment, the present invention could incorporate that prior art solution or one like it one order to locate pictures and associated tags for a dog, a tree and flowers. In that circumstance, as described above, the personal assistant software would translate “dog,” “tree” and “flower” into the registered foreign language and provide it to the user audibly and/or visually.

In addition, in a further embodiment, the present invention may also be used to collect, potentially translate and provide feedback regarding particular businesses, goods, services, etc. There currently exist numerous sites that allow the public to rate and comment on particular business such as yelp.com, tripadvisor.com, etc. The present invention provides a capability to expand and improve upon the capabilities of these sites. For example, in one embodiment, personal assistant software 120 on smartphone 117 can provide an interface for a user to rate (e.g., with stars, thumbs up/thumbs down, Like/Dislike) a business, product, travel destination, etc. and to comment on whatever was rated. This feedback may be stored in server 102, and the feedback may be segregated by foreign language group, country of origin, etc. Using the publicly available translation software discussed above, a subsequent user will be able to access any feedback regardless of the language the feedback was initially input in (e.g., a Russian user will be able to read reviews of a particular television submitted by a reviewers in Polish, Spanish, French, etc). In an optional embodiment, server 102 can also store or, alternatively, obtain feedback from registered native language databases (e.g., Yelp), translate that feedback and provide it to users as well as feedback. As a further option, if desired by a user, the personal assistant software can indicate to the user the particular feedback (if any) that had been translated and which feedback had not been. In addition to receiving as much feedback as possible, it may, for example, be particularly important to a Russian user, for example, to know what televisions are preferred by other Russian users of the present inventions.

The feedback option of the present inventions may further provide information stored in server 102 that could be valuable to third party businesses. For example, a particular business may be interested in what products Polish speaking residents of Chicago like and dislike. In an optional embodiment, the present inventions may equip third party business software on computer 112 with the capability for a third party business to search for such information for a fee. In one embodiment, the optional capability on computer 112 could allow a third party business to search for particular groups (local or nationwide) interested in particular products in order to subsequently target particular groups. Based upon the disclosure of the present inventions, one of ordinary skill in the art will understand that other third party business searches are possible.

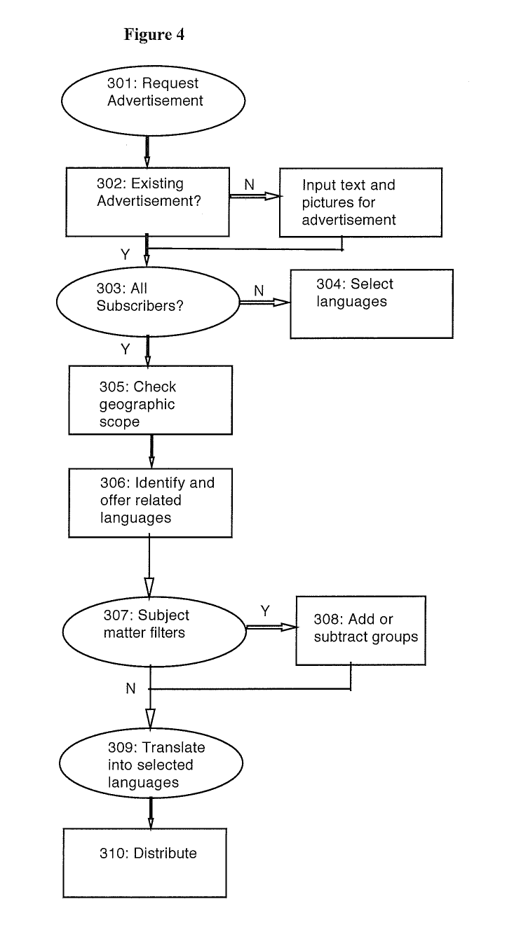

FIG. 4 illustrates that process by which an entity could submit a coupon, business advertisement, personal advertisement, classified advertisement or any other advertisement that will reach many users of the personal assistant software regardless of the language a user speaks. As used herein, advertisements include messages from government entities, personal newsfeeds such as twitter and social networking pages such as Facebook profiles. In addition, the entity providing the personal assistant software can of course use the system of the present invention to advertise itself. At step 301, a third party inputs to computer 112 a request, for example, to submit an advertisement. In an exemplary embodiment, in the case of advertisements such as a personal newsfeed or social networking profile, the system may be configured so that the advertisement is continuously input (or alternately input periodically) until the inputting party requests that the feed terminate. At step 302, software on server 102 asks the third party if the advertisement already exists (or if the advertisement exists as a personal newsfeed or social networking profile) or if the third party wishes to create an advertisement from pre-existing templates (or create a new personal newsfeed or social networking profile). In one embodiment, the present inventions provide a catalog of customizable templates for advertisements into which text (e.g., fields for price, time duration, etc.), pictures (e.g., box of Tide detergent), videos (e.g., on-line tour of store, a link to a Youtube commercial for a store) and other information can be input into the fields. One of ordinary skill in the art will be familiar with social networking software such as Facebook that allows individuals and businesses to create profile, and, in some embodiment, a similar user interface could be used to create advertisements. In an exemplary embodiment, the advertisement will be editable by an appropriate user so that an advertiser will be able to update information.

In an optional embodiment, advertisers may link together using known social networking techniques (e.g., a social network social as Facebook or business network such as LinkedIn). In this optional embodiment, the system may also provider advertisers that are linked together the option of communicating with other advertisers to purchase goods and services. For example, a Polish bakery and a Polish restaurant in Chicago could cooperate with one another to negotiate a volume discount from an oven manufacturer (that may or may not be an advertiser). The system may be configured such that one or more businesses may “invite” other businesses to become advertisers in order to realize efficiencies for small businesses.

In a further optional embodiment, in the event that an advertiser includes one or more videos with an advertisements (e.g., an on-line commercial), using speech-to-text software discussed above, the system can provide an advertiser the option to translate any dialog in the videos. For example, an advertiser would have the option to have dialog converted to text, and then that dialog would appear at the bottom of a video (e.g., subtitles used with films where the language spoken in a film is different than the predominant language spoken where a film is being shown). Using translation software discussed above, the subtitles may then be translated into different foreign languages.

At step 303, server 102 asks the third party if it wishes the advertisement to go to all foreign language groups or a subset of the groups including a subgroup of foreign languages and/or groups within a particular language (e.g, countries of origin). If the third party wishes to only transmit to a subset, at step 304, the third party selects the subgroup(s). One of ordinary skill in the art will recognize that there are numerous ways to accomplish that selection including, for example, a screen with boxes that can be checked. As one non-limiting example, a hierarchical menu could be provided with all foreign languages at the first level, countries of origin where a particular language is predominantly spoken at a second level. In an exemplary embodiment, once an advertiser has completed steps 303 and, if appropriate, step 304, the groups selected will be default preferences for that advertiser so that those steps need not be re-performed with subsequent advertisements or updates to an advertisement.

At step 305, the server determines the geographic scope of the advertisement—i.e., whether a coupon is intended for a local group (e.g., a local bakery) or nationwide (e.g., a product carried at groceries nationally). Optionally, at step 306, the server 102 will check its database to see if there are any related foreign languages the third party did not select. If there are a sufficient number of subscribers that speak that language within the geographical target area of an ad (e.g., more than a predetermined threshold), the third party will have the option to include that related language. For example, if one of the languages selected by the third party were Polish, the server would ask the third party if it would like to also select Slovak if a sufficient number of Slovak subscribers will be reached by the coupon. In an optional embodiment, an advertiser will have the option to add the related language to the default preferences. At step 307, server 102 will check the subject matter of the, for example, coupon against filters for all supported languages or the subset of selected languages. As a non-limiting example, if a third party submitted a coupon for steaks at a local grocery, one or more filters would identify that the coupon could be inappropriate for subscribers who had registered as speaking Hindi. As a further non-limiting example, the server 102 could store feedback from subscribers regarding products they like and dislike. In the event that a third party missed a group that, for example, likes the product being advertised, the filter will identify that group as well. If the filter identifies any particular groups that may need to be excluded (and/or included), at step 308, server 102 notifies the user of the particular group, and inquires whether the group should be excluded (and/or included). At step 309, the advertisement is translated into the foreign languages for each particular group. At step 310, server 102 distributes translated versions of the advertisements to particular groups either nationally or locally depending on the type of advertisement.

One of ordinary skill in the art will recognize that there are many ways to distribute the advertisements. In one exemplary embodiment, the advertisement can automatically be sent to all users in a particular group (e.g., by attaching a link to the advertisement in a user's registered email). In another exemplary embodiment, the system may employ real time location-based advertising in which the system is provided information on the actual location of users (e.g., via GPS) and advertisements are only pushed to users in a group within a certain distance from a particular business. One of ordinary skill in the art will be aware of real time location-based advertising systems currently deployed such as the Mobibo software product. In a further exemplary embodiment, if certain personal information is stored in the server 102, an advertiser may further refine the target audience and request that an advertisement only be distributed to that target (e.g., men in a particular age range also belonging to a selected language group). One of ordinary skill in the art will recognize that there will be many ways to customize the target audience.

In an optional embodiment, users of the personal assistant software will have the capability to customize preferences, and indicate, for example, goods or services that are not of interest. In that event, certain advertisements will not be distributed to a user even if he or she is in a particular group selected by an advertiser.

In addition, the personal assistant software may provide a user the option of managing and organizing received advertisements. For example, a user interface on a computing device may provide icons indicating items such as food, clothing, travel, etc., and advertisements falling into categories will be organized by those subject. If an icon is selected, in an exemplary embodiment, the user will be provided a list or other visual grouping of advertisements falling into the category of the icon. In a preferred embodiment, the list will also identify to a user the languages supported by advertisers. For example, advertisers that support the users primary registered language could be placed in one list (e.g., inbox), and other advertisers in another. Alternately, the entries in a list of advertisements could be color coded or linked to another visual indication to indicate languages supported (primary registered language, alternate language, related language and/or predominant language of the location).

In a further optional embodiment, the server 102 will monitor traffic on particular advertisements and store information concerning such traffic including, some or all of the following non-limiting information: group in which a user falls (e.g., country of origin), time of day an advertisement was viewed, location where a user resides, etc. Additionally, the server may periodically send advertisers reports regarding traffic either automatically or upon request by an advertiser.

Similarly, upon request, the server may also generate a report identifying the advertisements most viewed by one or more groups (e.g., which advertisements were most popular with Russians). For example, the report could comprise a message to a requesting party with links to advertisements most viewed by a selected group or groups.

While the example above is a coupon, the process illustrated in FIG. 4 could be used for all types of advertising, and is not limited to commercial advertising. As described above, in an exemplary embodiment, the process in FIG. 4 could also be used to submit classified advertising for employment. Related to the concept of employment advertising, trade unions may also wish to advertise using the present inventions (i.e., a carpenter's union may want to reach non-native speaking carpenters in a location). In an optional embodiment, the personal assistant software could provide an interface into which a user can enter an application for membership to that union which will be translated and then returned to the union.

Similarly, in an exemplary embodiment, the process in FIG. 4 could also be used to submit a personal advertisement for social purposes (dating, etc.). Likewise, the process illustrated in FIG. 3 could allow users to search for personal advertisements. In an optional embodiment, the personal assistant software could provide instant messaging capability (e.g., AOL Instant Messenger) with translation being carried out on server 102 (or another server equipped with translation software), allowing all users to interact regardless of their language.

As a further example, politicians in a particular country may submit political advertising and information concerning absentee voting to its citizens abroad. In an optional embodiment, personal assistant software may be configured to ask a user if he or she wishes to receive political advertising. As an additional option, where a language is spoken in multiple countries (e.g., Spanish), the personal assistant software may be further configured to ask the user to identify his country of origin (if he or she wishes to receive political advertising), and his or her country of origin in turn would be stored in server 102. While not necessary, the present invention could be modified to allow electronic voting by citizens abroad if electronic voting is permitted in a particular country. In that event, personal assistant software could provide a user interface through which a user can select candidates, ballot initiatives, etc., and then votes could be stored at server 102 and ultimately transmitted to the appropriate government official in a particular country.

Moreover, there are a number of optional feature that can be added to the subject matter described in FIG. 4. As discussed above, the present is useful as a tool for tourists to foreign language destinations. Advertisers in a particular location may only wish to pay to target tourists in a particular destination. In that event, using a user interface, the advertising input software on computer 112 could additionally allow a third party business to identify tourists as the intended target audience (or, alternately, exclude tourists as a target audience). In the case of daily coupons as an example, this feature will allow coupons to reach a more targeted audience and will also create more ad space for potential advertisers.

In a further optional embodiment, as described above, databases 102B in server 102 can include calendars associated with each group that uses the personal assistant software. In this optional embodiment, third party businesses can submit advertisements (e.g., coupons) specifically tailored to a holiday celebrated by one or more groups (e.g., the Chinese Lunar New Year). While not necessary, in an embodiment, server 102 could also maintain a database of past and potential advertisers, and, prior to a particular holiday, email those advertisers suggesting advertisements targeted at a particular holiday. In a further embodiment, software on server 102 could be configured to check weather reports provided by, for example, the National Weather service, and suggest advertising to local merchants based on both a particular groups' calendar and the weather forecast. For example, if rain is forecast on the date for the Pulaski Day Parade in Chicago, the software could suggest that Chicago business provide coupons for umbrellas, rain coats, etc. to Polish users of the personal assistant software in Chicago.

In a further optional embodiment, the steps used in FIG. 4 could also be used by government entities to alert foreign language speakers to health and safety issues. For example, a local police department may wish to issue an alert to groups who do not typically watch local news due to language barriers. As another example, a school district might wish to warn non-native speaking parents regarding an influenza outbreak. Like business advertisements described above, the government entity would enter the alert, for example, in fields on computer 112, the alert would be translated into allow languages spoken by users in that location, and then distributed by registered language to users. Optionally, users of the personal assistant software could provide information about themselves when first registering with the personal assistant software (e.g., identifying themselves as parents) that would then be stored on the server 102 so that such government alerts would only be transmitted to appropriate users of the personal assistant software. In an alternative embodiment, the personal assistant software would store information about the user on the user's device itself. The information would then be used by the server 102 only at the time when government alerts are transmitted.

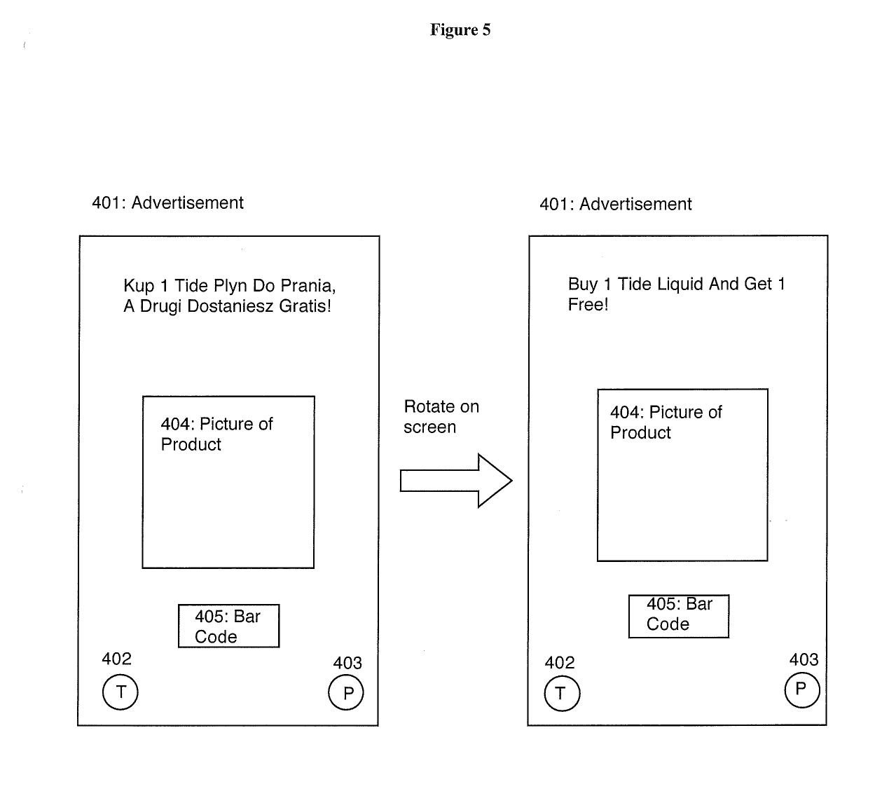

FIG. 5 illustrates a user interface for business advertisements (e.g., coupons) that also serves as a tool for learning a different language. Flash cards are a tool often used for learning a new language. The user interface shown in FIG. 5 makes a business advertisement into a flash card with foreign language and native language translation. In the preferred embodiment, an advertisement 401 (in this non-limiting example a coupon) would appear on the display of a smartphone 117 (or tablet computer, on-board navigation system, etc.). In an exemplary embodiment, the advertisement 401 could include a picture of a product 404, a bar code 405 and accompanying text. In an alternative embodiment, the bar code 405 could be replaced with a “Buy” button By way of non-limiting example, the text could be “Buy 1 Tide Liquid And Get 1 Free!” In one embodiment, an icon 402 at the bottom of the advertisement which could, for example, include the word “translate” in the user's language would notify the user that the advertisement could be translated. When tapped on, for example, a touchscreen, the advertisement would appear to flip like a flash card on the display screen, revealing the translated advertisement on the other “side.” In the above example, if the registered user understood Polish, the coupon would appear in the user interface to be “flipped” to read “Kup 1 Tide Plyn Do Prania, A Drugi Dostaniesz Gratis!” In another embodiment, the user interface could be configured so that a left to right (or right to left) finger swipe (commonly used on an iPhone) or an up/down swipe, etc. would reveal the other “side” of the flash card. In another embodiment, the user interface of the personal assistant software could be configured to recognize a verbal translation command to “flip” the flash card. One of ordinary skill in the art will recognize that the arrangement of text, pictures and icons in the interface of FIG. 5 is exemplary, and could be modified.

To aid in learning, the smartphone 117 could also read aloud via the speaker the advertisement in the translated language when commanded by the user. The user command could be verbal, could be activated by an optional icon 407, etc. In a further embodiment, one or more words in the advertisement could be selected by touching the words in the case of a touchscreen or by manipulating a cursor. In this embodiment, when commanded by the user verbally, by manipulation of the icon 407, etc., the smartphone would only read aloud the selected words in order to assist a user with, for example, pronunciation of difficult words.

In a further exemplary embodiment, the advertisement/flash card could also include a further information icon 406, allowing a user of the personal assistant software to learn about the company or the product being advertised (e.g., the fine print). As one of skill in the art will appreciate, by selecting the “further information” icon 406 (e.g., by touching it on the screen), a user will be able to move in a hierarchy to one of more additional screens of information. These information screens can also be flash cards that can be “flipped” if desired by the user.

In a further exemplary embodiment, the “further information” icon 406 can provide directions within a store to the particular product being advertised. For example, in larger stores with multiple departments (e.g., a sporting goods store with multiple floors, a large department store, etc.), it may be difficult for an individual to follow in-store directions in the predominant language of the location, or the individual may not feel comfortable asking an employee for directions. The user of the personal assistant software will therefore be able to use the in-store directions to locate a product while also learning a language in real time (if he or she chooses to use the flash card feature with the directions).

In addition to acting as a teaching tool, the user interface illustrated in FIG. 5 will also make shopping easier by expanding options for non-native speakers and/or tourists. For example, a non-native speaker could “flip” a coupon from a foreign language version to a translated version upon request by a cashier. Belatedly, in an optional embodiment, the user interface of FIG. 5 could include an icon 403 that would enable printing advertisements on paper. In one embodiment, pressing the icon 403 would result in the user being queried whether he or she wants the advertisement printed in multiple languages via, for example, a pop up window. One of ordinary skill in the art will recognize that the translated advertisements could be printed on double sided paper, by splitting the paper in half, etc. This feature will ease, for example, presentation of multiple coupons at grocery shopping without potential confusion by a cashier or the shopper who speaks a different language.

In a further exemplary embodiment, the personal assistant software provides a mechanism to filter incoming phone calls and to translate voicemail messages for a user. Users of smartphones and other communication devices generally receive calls from numbers with which a user is not familiar. Some of these calls are from unwanted telemarketers, and some calls are sources such as a utility company where the number is unfamiliar but the information is important. Smartphone users that speak the predominant language of the location can readily determine whether they want to speak with the unidentified caller—either by picking up the phone or by listening to a voicemail message (if any). A user that does not speak the predominant language, however, will have difficulty distinguishing important information from information he or she wishes to ignore.

To overcome that problem, in the exemplary embodiment, the personal assistant software (or alternately another software module provided with or separate from the personal assistant software) provides a user the option to configure his or her communication device (e.g., smartphone) to automatically send certain incoming phone calls into voicemail. Exemplary filtering configurations include (but are not limited to): (1) all 1-800 calls, (2) calls from any number not in a user's contacts stored on the phone; (3) calls from numbers that a user has not dialed previously (stored, for example, in a Recent Calls List); and (4) any and all combinations of the foregoing. A user will also be able to manually ignore calls (e.g., by pressing an Ignore button on a touchscreen) or by letting the phone ring until it goes to voicemail.

For calling parties who were ignored (either automatically, manually or by letting the phone ring long enough), the personal assistant software will play a message asking the calling party if he or she will be recording a message in the predominant language of the location or the registered primary language of the user, and requesting the calling party to select a language option. As will be well understood by ordinary artisans, the language selection can be accomplished in many ways. For example, a calling party could be directed to press a “1” on a keypad or touchscreen for the primary registered language of the user or a “2” for the predominant language of the location. In an exemplary embodiment, the preceding message will be played in both the predominant language of the location and the user's primary registered language. In a further embodiment, in the event that a calling party selects the registered primary language of a user, the calling party may be directed to a personalized greeting recorded by the user (if the user has recorded that greeting). In the event that a user does not record a personalized greeting, the personal assistant software will provide a standard greeting (e.g., “The subscriber you have called is not available. Please leave a message at the tone.”) in both the primary registered language of the user and the predominant language of the location.

In an optional embodiment, the user of the personal assistant software optionally could input input text corresponding with his or her personalized greeting which would then be translated into the predominant language of the location using translation software described above. Likewise, using speech-to-text software and translation software described above, the personalized greeting could be converted to text and then translated into the predominant language of the location. Then, using text-to-speech software such as the system described in U.S. Pat. No. 6,847,931 which is incorporated by reference, this translated text of the greeting could be read by a computer and played for calling parties that select the predominant language of the location.

In an exemplary embodiment, the text-to-speech software is stored in and executed by the server 102, and it may be a separate module or combined with one more modules on server 102 (e.g., speech-to-text software). The text-to-speech may also be stored in and executed by a third party server that provides an application programming interface to text-to-speech software.

The messages recorded in different languages may be stored in separate mailboxes in memory of the smartphone (or other device) and/or server 102 (or a separate voicemail server). Alternately, the messages may be stored in memory in the same mailbox with an indication to distinguish the language of the recording. Likewise, the personal assistant software may optionally allow a user to configure the user interface on a smartphone (or similar computing device) associated with voicemails and/or missed calls so that there is an indication of the language used by the calling party. For example, a hierarchical menu could be used to allow a user to navigate between voicemail message types. Alternately, the user interface could list all voicemail messages and include a check mark (or other visual indication) next to voicemail messages in the user's primary registered language.

In a further optional embodiment, a user will be able to configure the personal assistant software to handle automated calls. In the event that a selection is not made between either language within a period of time (e.g., 20 seconds), at the option of the user, any recording from the automated call with either be placed in the predominant language of the location mailbox or ignored.

Using the software discussed above, stored messages from calling parties speaking the predominant language of the location will be converted into text and then translated into the primary registered language of the user. The translated messages may be presented to the user in a standard user interface (e.g., a graphical user interface for an inbox), and, optionally, the messages be read aloud to the user via text-to-speech software if at a user's request.

Further, using the system of the present invention, the personal assistant software may provide users a number of options for responding to messages recorded in the predominant language of the location. In one optional embodiment, a user may input a response (via text or speech), the response will be translated (as described above) and the translated response will be transmitted to the number of the calling party via SMS, VoIP messaging or another similar messaging service. In a further optional embodiment, either automatically or at the request of a user, one or more words included in the translated message (e.g., words matching particular types of businesses and services) will be run through the search illustrated in FIG. 3. As described above, for a particular translated message, the personal assistant software will provide the user suggestions for contacts that speak the users language that may be able to assist with the subject matter of the message. In a further optional embodiment, if the personal assistant software recognizes the name of a business (e.g., a name stored in server 102) and that business has a web site, the personal assistant software can provide a user a link to the company's web site (e.g., a utility company web site) and automatically translated the web site (as described above).

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Any relevant software may be used in the devices described in connection with the present invention. Coding the computer software (e.g., the personal assistant software, the third party business software and databases, filers and software on the server) would be routine in light of this disclosure. One of ordinary skill in the art would recognize that the software could be programmed in any one of numerous computer languages (e.g., C, C++, Java, etc.) or a combination of those languages. Similarly, databases used in the present invention could be created used by publicly available packages such as MySQL

Moreover, it will be appreciated that various modifications and alterations may be made by those skilled in the art without departing from the spirit and scope of the invention. The invention is not to be limited by the foregoing illustrative details, but is to be defined according to the claims. Although only certain exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention as defined by the appended claims.

1. A server comprising:
a transceiver coupling the directory server to one or more registered users via a network;
a first database of one or more entities searchable by registered users, the database including identifying characteristics of each of the one or more entities and the one or more languages supported by each of the one or more entities, further wherein each of the entities having a physical location support at least one language other than the predominant language of the physical location, and further wherein the database includes at least one entry for at least three different languages.

2. The server of claim 1, wherein the identifying characteristics include the types of good or services offered by entities that are commercial entities.

3. The server of claim 1, further including a second database of groups classified by the language spoken by a group and/or country of origin for members of the group, wherein the second database further identifies one or more characteristics of the group.

4. The server of claim 3, wherein the characteristics of a group include events in a calendar associated with the group.

5. The server of claim 1, wherein the server includes memory storing translation software configured to translate information stored in the server into one or more different languages.

6. The server of claim 1, wherein the directory server is coupled to a second server that provides translation software.

7. The server of claim 1, wherein the server includes memory storing speech recognition software configured to recognize a verbal search for an entity input into a computing device of a registered user.

8. The server of claim 1, wherein the server includes memory storing visual search software configured to recognize on or more contents of a picture or video and to provide a description of the one or more contents of the picture or video.

9. The server of claim 9, further wherein the memory stores translation software that is configured to translate the result(s) of a search by the visual search software into one or more languages.

10. The server of claim 1, wherein the server includes memory storing instructions configured to handle registered user searches for entities based at least in part on the physical location of a searcher and primary language spoken by a searcher.

11. The server of claim 1, further wherein the identifying characteristics includes the physical location of one or more of the entities.

12. The server of claim 11, further wherein the database periodically updates the physical location of mobile entities.

13. The server of claim 3, wherein the second database further identifies languages that include shared words and/or similar words.

14. The server of claim 3, wherein the first of second database further comprises links to web sites translated into one or more languages.

15. The server of claim 1, wherein the server includes memory storing instructions configured to use web based translation software to translate web sites into one or more languages.

16. The server of claim 3, wherein the first or second database stores information identifying registered users including the primary language spoken by a user.

17. The server of claim 16, wherein the information identifying registered users includes the dialect or sub-dialect of a primary language spoken by a user.

18. The server of claim 16, wherein the information identifying registered users includes an individuals' preference for the dialect or sub-dialect for translations of information.

19. The server of claim 3, wherein the first or second database tracks the traffic for individual entities.

20. A portable communication device comprising:
a processor;
a transceiver coupling the portable communication device to a server via a network;
a memory coupled to the processor;
wherein the memory stores software that is configured to receive user searches for entities based on at least type of business, products and/or services and to automatically perform the search based in part on proximity to the user and the primary registered language of the user; and
a display.
